(19) United States
(12) Patent Application Publication
(10) Pub. No.: US 2016/0132917 A1
(43) Pub. Date: May 12, 2016

(54) LOCATION BASED MARKETING

(71) Applicant: XOOKER, LLC, Lexington, KY (US)

(72) Inventors: Conrad R. Carney, II, Lexington, KY (US); Tom Nickell, St. Louis, MO (US); Greg Hammond, St. Louis, MO (US)

(73) Assignee: XOOKER, LLC, Lexington, KY (US)

(21) Appl. No.: 14/896,165

(22) PCT Filed: Jun. 4, 2014
(86) PCT No.: PCT/US14/40920

§ 371 Date: Dec. 4, 2015

Related U.S. Application Data
(60) Provisional application No. 61/830,825, filed on Jun. 4, 2013.

(51) Int. Cl. G06Q 30/02; H04W 4/02; G06Q 30/06

(52) U.S. Cl. CPC G06Q 30/0209; G06Q 30/0641; H04W 4/02

(57) ABSTRACT

A location-based marketing method includes steps of providing at least one first computing device including at least one memory operatively coupled to at least one processor, the at least one memory storing at least a listing of participating vendor geographical locations. At least one second computing device is in computing communication with the at least one first computing device. The method further includes steps of displaying to a user on a display screen of the second computing device a rotatable three-dimensional navigational interface including a plurality of faces, and by a geolocator module of the second computing device, providing to the at least one first computing device a geographical location of the user. The user geographical location is compared to the stored listing of participating vendor geographical locations. On determining a match, the first computing device initiates a user check-in procedure specific to the matching participating vendor.

This utility patent application claims the benefit of U.S. Provisional Patent Application Ser. No. 61/830,825 filed on 4 Jun. 2013, the entirety of the disclosure of which is incorporated herein by reference.

### TECHNICAL FIELD

This document relates generally to games and applications and more particularly to a computer-implemented integrated location-based marketing system and method which includes a game as an aspect thereof.

### BACKGROUND OF THE INVENTION

This disclosure relates to an interactive marketing platform or integrated location based marketing system that allows local and national businesses to market to consumers using IIM (Integrated Interactive Marketing), to help build their consumer base. The system uses a custom-built mobile application that can run, for example, on consumer smart phones or other mobile and desktop computing devices to allow them to locate local and national businesses that are close to their location and earn rewards by visiting them.

Local businesses, and national businesses with a local presence, can likewise use the disclosed system to reach consumers in their areas. This system automatically promotes these businesses when users are physically close to their location. By using “Location Based Marketing” to help target users in a geographical area, a business is able to capitalize on the number of new users gained and to turn those users into repeat buyers.

This system includes a one-stop marketing site for both businesses and consumers. This system can be accessed through any suitable computing device, including without limitation laptops, netbooks, smartphones, electronic readers, cell phones, personal digital assistants, tablet computers, other handheld or desktop computing devices, personal computers, etc. via the disclosed application.

Business owners are becoming more concerned with the time and expense of monitoring various social media utilized by users, often requiring monitoring through multiple channels. This system also provides businesses with a way to automatically update social media applications such as a FACEBOOK page and TWITTER feed with their latest offers, all from a single, web-based portal or mobile application.

### SUMMARY OF THE INVENTION

A location-based marketing method comprises: receiving, by a computing device or server, a participating user location from a mobile or other computing device of the participating user and comparing, by the computing device, the participating user location to a stored list of participating list of vendor locations. If the participating user location corresponds to one of the participating vendor locations, the method includes initiating, by the computing device, a vendor check-in procedure on the mobile or other computing device of the participating user. A map displaying participating vendor locations within the predetermined distance of the participating user location may be displayed at any time by the participating user, such as by clicking an appropriate icon.

The check-in procedure may include initiating at predetermined time intervals, by the computing device, displaying of a vendor promotional video on the computing device of the participating user and a vendor threshold reward status including displaying of any currently earned reward or remaining requirement to earn the next reward. The predetermined time intervals may vary according to user mobility and location. Further the check-in procedure includes updating, by the computing device, the game status of the participating user visiting the participating vendor location. In addition the method includes initiating, by the computing device, a marketing game played by the participating user.

In accordance with an additional aspect a non-transitory machine readable storage medium comprises instructions that, when executed by one or more processors of the machine, cause the machine to perform operations comprising: receiving a participating user location from a mobile computing device of the participating user; comparing the participating user location to a list of participating vendor locations; if the participating user locations corresponds to one of the participating vendor locations, initiating a vendor check-in procedure on the mobile computing device of the participating user; and if the participating user location does not correspond to one of the participating vendor locations, providing other options, including by the user displaying a map displaying participating vendor locations within a predetermined distance of the participating user location.

In addition, an apparatus comprises: an interface to communicate with participating users of a location-based marketing game; a memory to store data associated with the location-based marketing game; and at least one processor coupled to the interface and the memory. The at least one processor is configured to: receive a participating user location from a mobile computing device of the participating user; compare the participating user location to a list of participating vendor locations; initiate a vendor check-in procedure on the mobile computing device of the participating user if the participating user location corresponds to one of the participating vendor locations; and initiate a map displaying participating vendor locations within a predetermined distance of the participating user location if the participating user location does not correspond to one of the participating vendor locations.

### BRIEF DESCRIPTION OF THE DRAWING FIGURES

The accompanying drawing figures incorporated herein and forming a part of the specification, illustrate several aspects of the computer implemented method of location based marketing and together with the description serve to explain certain principles thereof. In the drawings:

FIG. 1 is a block diagram of an exemplary system for implementing the location based marketing method and rewards program;

FIG. 2 is a block diagram of an exemplary computing device usable in the system illustrated in FIG. 1;

FIG. 3 is a block diagram illustrating various communication portals to the game system;

FIG. 4 is a flow diagram exemplary of the location based marketing game;

FIG. 5A is a flow diagram exemplary of a vendor check-in procedure;

FIG. 5B is an illustration of an exemplary user interface for vendor check-in on a mobile computing device of a participating user;

FIG. 6A is a flow diagram exemplary of a method of providing a participating user with information about vendors having vendor locations within a predetermined distance of the user location;

FIG. 6B is an illustration of an exemplary user interface for providing a user with information about vendors having vendor locations within a predetermined distance of the user location;

FIGS. 7A-7D are a continuous series of flow diagrams illustrating a location based marketing game and reward program;

FIG. 8 is an illustration of a three-dimensional navigational interface according to the present disclosure;

FIG. 9 is an illustration of a face of the three-dimensional navigational interface of FIG. 9, showing a grid of user-selected participating vendors;

FIGS. 10A and 10B show the grid of FIG. 9, with the grid of FIG. 9 replaced by a grid of hidden prizes available to a user (FIG. 10A) and a grid of revealed prizes available to the user (FIG. 10B);

FIG. 11 is an illustration of a face of the three-dimensional navigational interface of FIG. 9, showing a set of tabs for displaying a list of participating vendors, a map functionality, a list of past user check-in procedures, and a log of points accrued by a user;

FIG. 12 shows the face of FIG. 11, with the map functionality displayed;

FIG. 13 is an illustration of a face of the three-dimensional navigational interface of FIG. 9, showing a vendor offer displayed to a user; and

FIG. 14 is an illustration of a face of the three-dimensional navigational interface of FIG. 9, showing a grid of user-accessible games.

Reference will now be made in detail to the present preferred embodiment of the location based marketing method and reward program, an example of which are illustrated in the accompanying drawings.

### DETAILED DESCRIPTION OF THE INVENTION

Certain aspects of the present disclosure are discussed in greater detail in U.S. Published Patent Appl. No. 2012/0253902 filed on Mar. 30, 2012, the entirety of which is incorporated herein by reference.

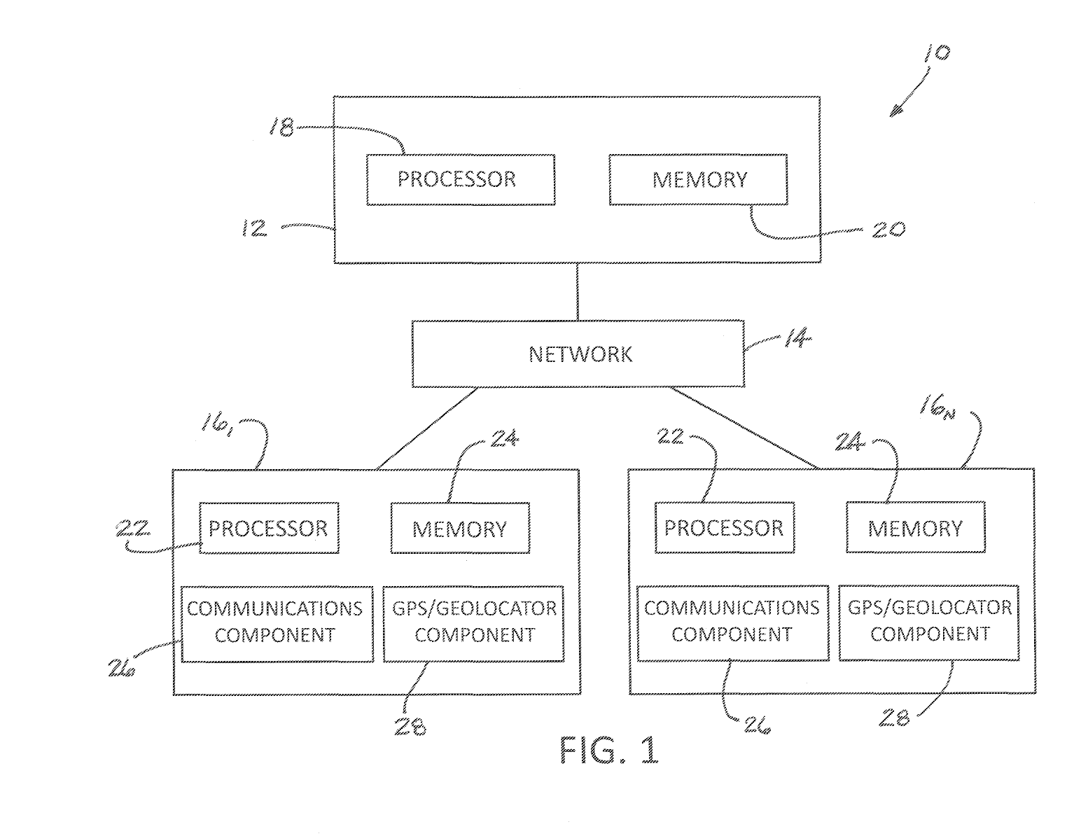

Reference is now made to FIG. 1 illustrating a representative computing system environment 10 which may comprise a computing device, base unit or computing device 12 that communicates over a network 14 with a mobile computing device 16₁. Typically, the computing device 12 communicates with one or more desktop or mobile computing devices schematically illustrated as 16₁-16_{N}. The computing device 12 may include a processor 18 and a memory 20. The memory 20 may be utilized to store, for example, instructions that cause the processor 18 to perform various tasks and steps of the novel location-based marketing game described in detail below. The memory 20 may also be utilized to store, for example, a list of participating vendors and vendor locations, vendor promotional videos, vendor threshold reward status, game status, vendor deals or offers and the like. It will be appreciated that computing device(s) 16₁ . . . 16_{N} may be stand-alone devices, or may be configured to synchronize one with the other, for example in the situation where each of computing device(s) 16₁ . . . 16_{N} owned by a single user automatically synchronizes to share information with every other one of computing device(s) 16₁ . . . 16_{N} owned by the user.

Each computing device 16₁ . . . 16_{N} includes at least one processor 22, at least one memory 24, a communications component 26 and a geolocator component 28, for example a GPS unit. The memory 24 may be utilized to store a mobile application including instructions that when executed by the processor 22, cause the mobile computing device computing device(s) 16₁ . . . 16_{N} to operate in accordance with any function described herein. For example, memory 24 may include computer executable instructions for viewing a vendor video, for redeeming a vendor threshold reward, or for selecting a game reward as described in greater detail below.

The communications component 26 interfaces with the processor 22 and facilitates wired or wireless communication with external systems such as the computing device 12 over the network 14. The network 14 may comprise any network of a type now known in the art or developed in future, including but not limited to a local area network (LAN), a wide area network (WAN), a wireless network, wi-fi, or any other network or network of networks including that generally known as the Internet. The geolocator component 28 may include a location application of a type known in the art. Alternatively, or in addition, the geolocator component 28 may include a global positioning system (GPS) receiver for identifying a geographical location of the computing device(s) 16₁ . . . 16_{N}. Regardless of its configuration the geolocator component 28 is capable of accurately identifying a geographic position of the mobile computing device(s) 16₁ . . . 16_{N} being utilized by the participating user of the location-based marketing system.

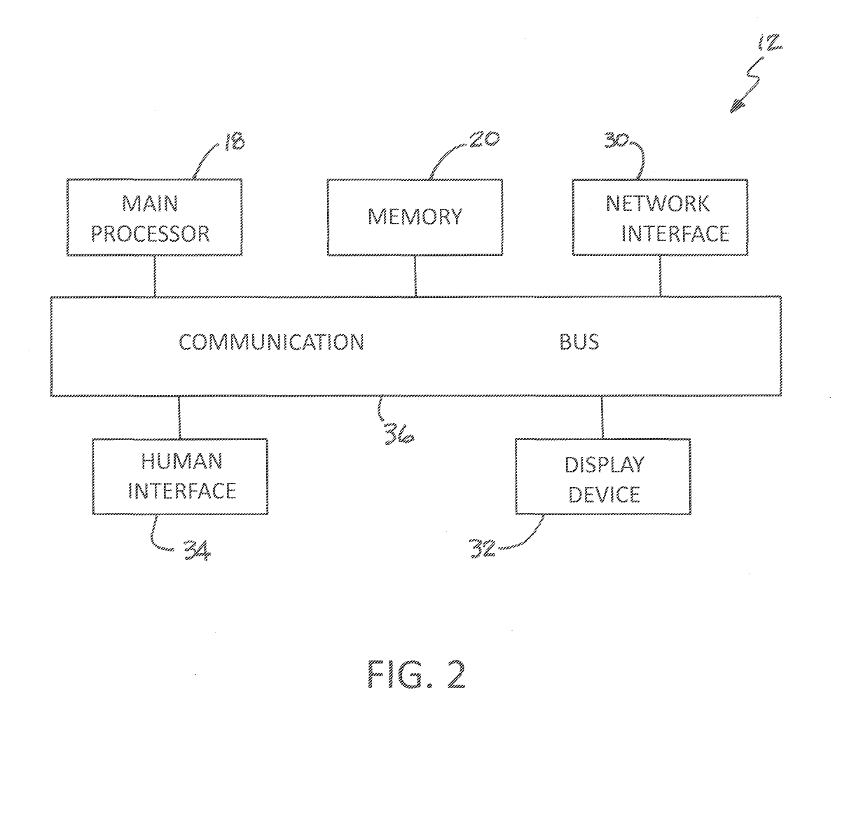

Reference is now made to FIG. 2 illustrating the computing system environment 10 including the computing device, base unit or computing device 12. As illustrated the computing device 12 includes one or more processors 18 and one or more memories 20. The computing system environment 10 also includes one or more network interfaces 30 and one or more input/output devices such as display devices 32 and human interfaces 34. As should be appreciated, all of these components are capable of communicating with one another, such as over a communications bus 36.

In one particularly useful embodiment, the computing device 12 takes the form of a server. It should be appreciated, however, that substantially any computing device having a processor can be utilized. Thus, the computing device 12 may also take the form of a laptop, digital assistant, tablet computer, personal computer, or other computing device able to execute computer readable instructions and having sufficient processing power to accomplish the computing tasks described herein.

The processor 18 may be referred to as a main processor or central processing unit (CPU). The processor 18 may include a single or multiple processing cores. Where two or more cores are provided, the cores may be capable of operating in parallel.

The memory 20 may comprise any number and combination of memory devices including but not limited to cache memory, such as static random access memory (SRAM), dynamic random access memory (DRAM), enhanced DRAM or the like. Any storage repository or non-transitory machine readable storage medium of a type known in the art may also be used. The processor 18 accesses the memory 20 through the communications bus 36 to access any application or data stored thereon including, but not limited to, any computer readable instructions.

The network interface 30 may be used to interface with any network 14 including but not limited to the Internet. The input/output devices may comprise one or more computer monitors, printers or other display devices 32 as well as human interfaces 34 including but not limited to keyboards, mice, pointers, microphones, speakers or the like.

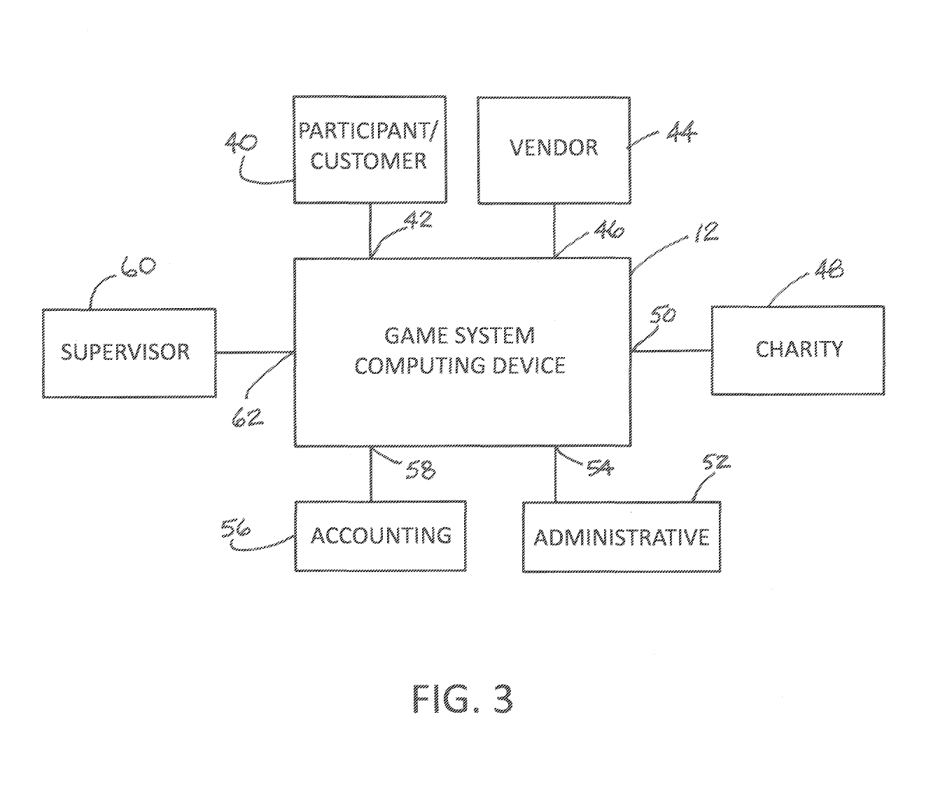

One or more classes of users of the disclosed system are contemplated. In the embodiment shown in FIG. 3, the game system computing device 12 is accessed by six different classes of users. In this embodiment, the participant user 40 accesses the computing device 12 through a participant user access port 42. The vendor user 44 accesses the computing device 12 through a vendor access port 46. A charity user 48 may access the computing device 12 through a charity access port 50. An administrative user 52 may access the computing device 12 through an administrative port 54. An accounting user 56 may access the computing device 12 through an accounting port 58. Finally, a superuser 60 may access the computing device 12 through a superuser port 62.

Different registration and access privileges may be associated with different classes of users. For example, a participant user 40 is able to register, download, configure and use the location-based marketing game, interact with areas of the related website that are only accessible to logged in users, play the game, buy special vendor deals and reap vendor rewards through their computing device(s) 16₁ . . . 16_{N}. Vendor users 44, i.e. duly authorized representatives of participating vendors such as restaurants and retailers, may use the vendor port 46 to upload and manage the various deals they are offering to the participant users. Vendor users 44 will also be able to review reports on user participation, dollar amounts sold and dollar amounts paid as part of the prepaid deal portion of the application. The vendor port 46 also allows the vendor user 44 to upload and schedule promotional videos viewed by participant users on their computing device(s) 16₁ . . . 16_{N} upon check in. Other account maintenance functions are also accessed by the vendors 44 through the vendor port 46.

A charity 48 may receive monetory donations in exchange for participant user's participation in the various promotions. Through the charity port 50 a charity user 48 may invite participant users to participate in their charitable program as well as view various reports on a number of users and dollar amounts earned and paid through the system. A charity user 48 may also edit and maintain contact info and accounting info about the charity through the charity access port 50.

Administrative users 52, such as customer support and sales reps of the location-based marketing company offering the game, may access computing device 12 through the administrative access port 54 so as to manage all aspects of users, vendors, charities, deals, banner ads and other functions such as user comments and the customer support knowledge base. Administrative personnel 52 utilizing the administrative port 50 also have access to the vendor and charity ports 46, 50 so that they may assist participant, vendor and charity users 40, 44, 48 with any issues they may be encountering with system operation and functions.

Accounting personnel 56 may access the computing device 12 through the accounting access port 58 to gain access to accounting functions within the system that should not be available to customer support or sales people. Accounting personnel 56 utilizing this port 58 would typically be responsible for paying vendors and charities for their participation in any prepaid deal and gift card portions of the system. Such users 56 will also be able to review reports showing money owed as well as statements showing when and how much has been paid to vendors and charities. The accounting personnel 56 will also be able to review sales activity reports for prepaid deals and gift card sales.

Superusers 60 will be able to access the computing device 12 through the superuser access port 62 and thereby have rights and permission to all other user ports 42, 46, 50, 54, 58 for system wide access and activity such as sales, products sold, banner ad revenue, sponsored deal revenue and other data needed for executive management of the business.

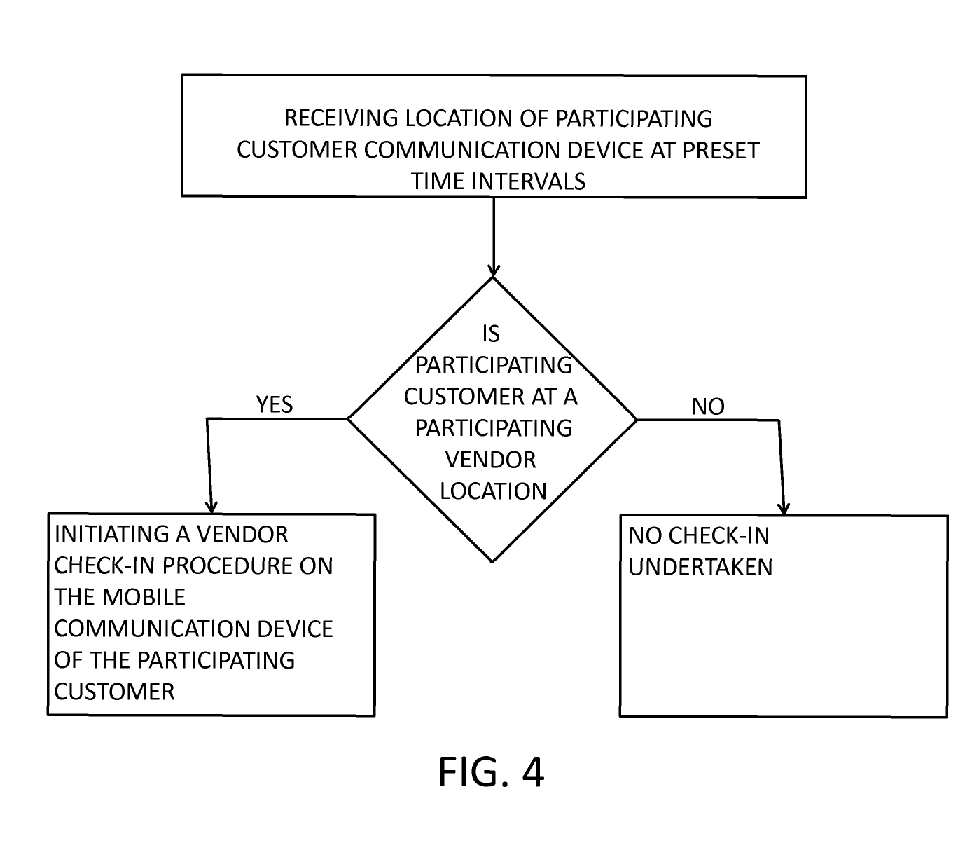

As illustrated in FIG. 4, the location-based marketing method may be generally described as comprising: receiving, by a computing device 12, a participating location from on or more computing device(s) 16₁ . . . 16_{N} of a participating user and comparing, by the computing device 12, the participating user location to a stored database of participating vendor locations. If the participating user location corresponds to one of the participating vendor locations, the method includes the step of automatically initiating, by the computing device 12, a vendor check-in procedure on the computing device(s) 16₁ . . . 16_{N} of the participating user.

If the participating user location does not correspond to one of the stored participating vendor locations, other options may be presented. For example, the user may initiate display of a map displaying participating vendor locations within a predetermined distance of said participating user location, such as by clicking or tapping an icon to cause the map to display, by accessing a tab or a drop-down menu, or by combinations of known such methods.

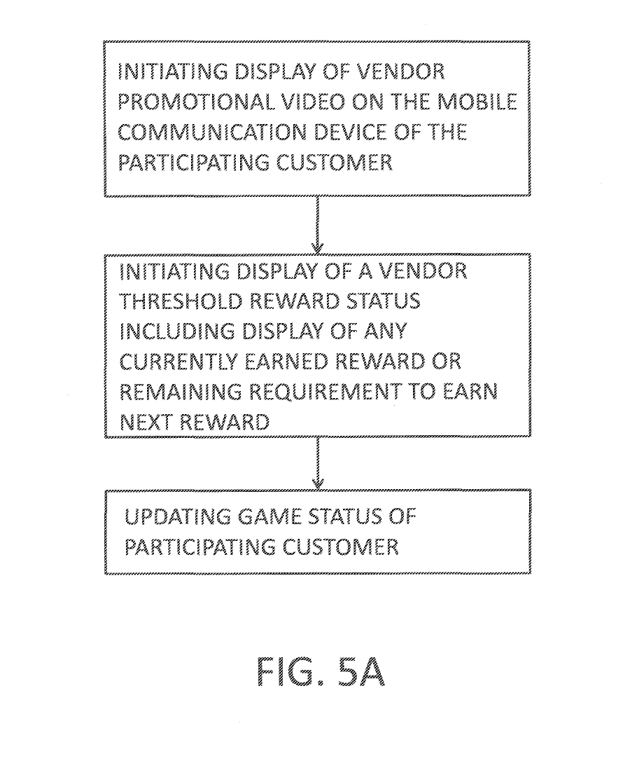

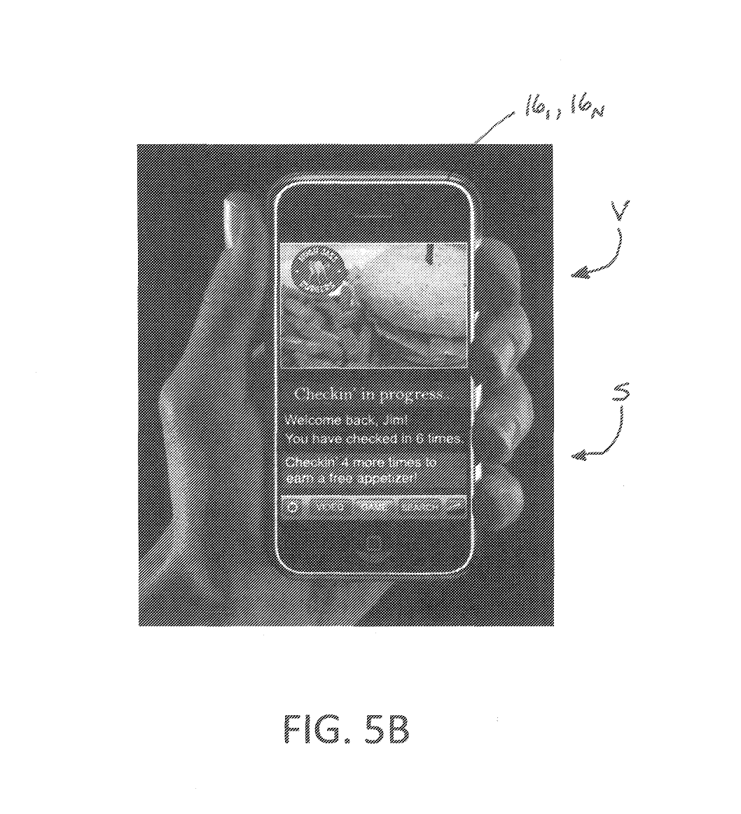

As illustrated in FIG. 5A, the check-in procedure may include initiating, by the computing device 12, display of a vendor promotional video on the computing device(s) 16₁ . . . 16_{N} of the participating user. This process may be optional or may be automatically initiated as part of the user check-in process. Such a video may inform the user about new vendor products or services, offer the user special deals, thank the user for visiting the vendor or take other actions which may promote the business of the vendor. The check-in procedure may also include initiating, by the computing device 12, displaying of a vendor threshold reward status including displaying of any currently earned reward or remaining requirement to earn the next reward. In addition, the check-in procedure may further include updating by the computing device 12, game status of the participating user visiting the participating vendor location. FIG. 5B illustrates a mobile computing device 16₁ . . . 16_{N}, in the form of a smartphone, cycling through a representative check-in procedure including a display of the promotional video V and a display of the threshold reward status S. Of course, each of these latter steps may also be mandatory or optional, in various embodiments.

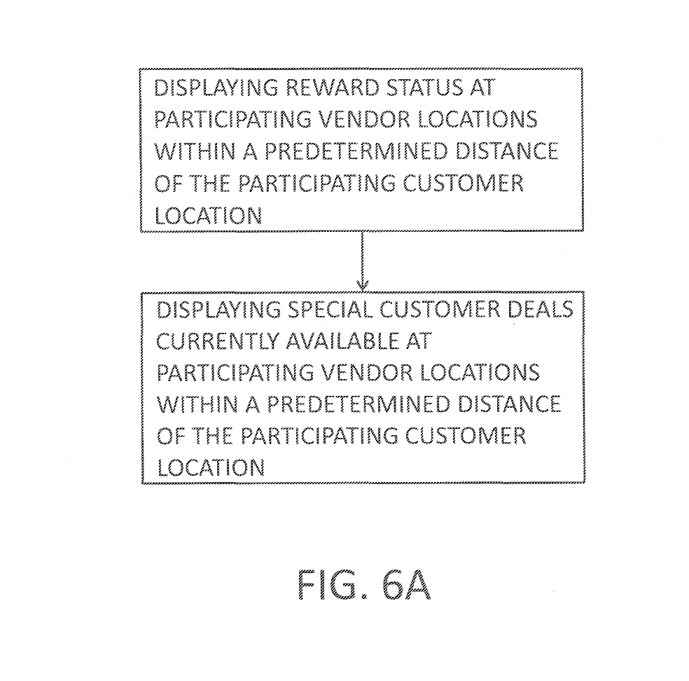

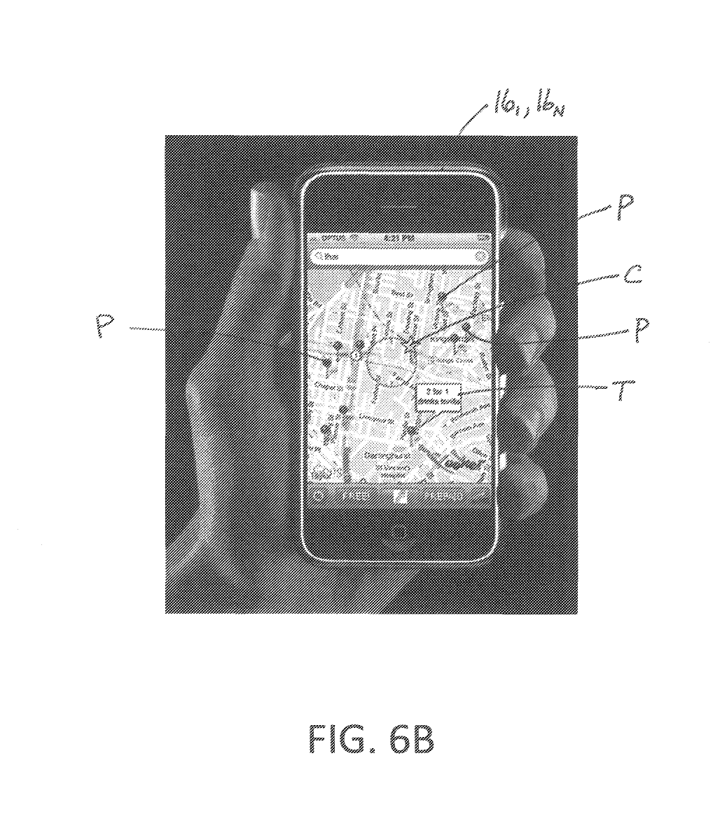

As illustrated in FIG. 6A, when the participating location does not match one of the stored participating vendor locations a vendor location map may be displayed as a user-accessible option. It should be appreciated that the map may also automatically or optionally display reward status of participating vendor locations within a predetermined distance of the participating user location and special customer deals currently available at participating vendor locations within a predetermined distance of the participating user location. FIG. 6B illustrates a mobile computing device 16₁ . . . 16_{N} of a participating user in this mode of operation showing a map centered on the participating user's location and displaying graphic renditions of “pushpins” P to indicate to the user participating vendor locations within a predetermined distance (such as two miles) of the participating user location. As other options, different colored stars or chests C may indicate availability of a reward the participating user can earn by visiting a particular participating vendor location and call outs (note text balloon T) display a sponsored deal of the day at a particular user location.

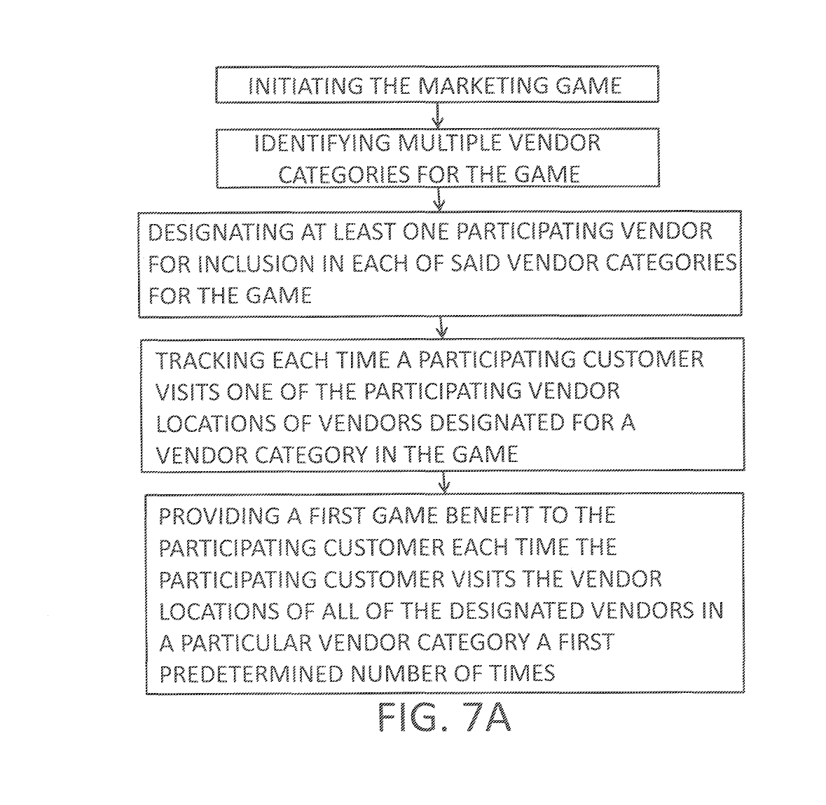

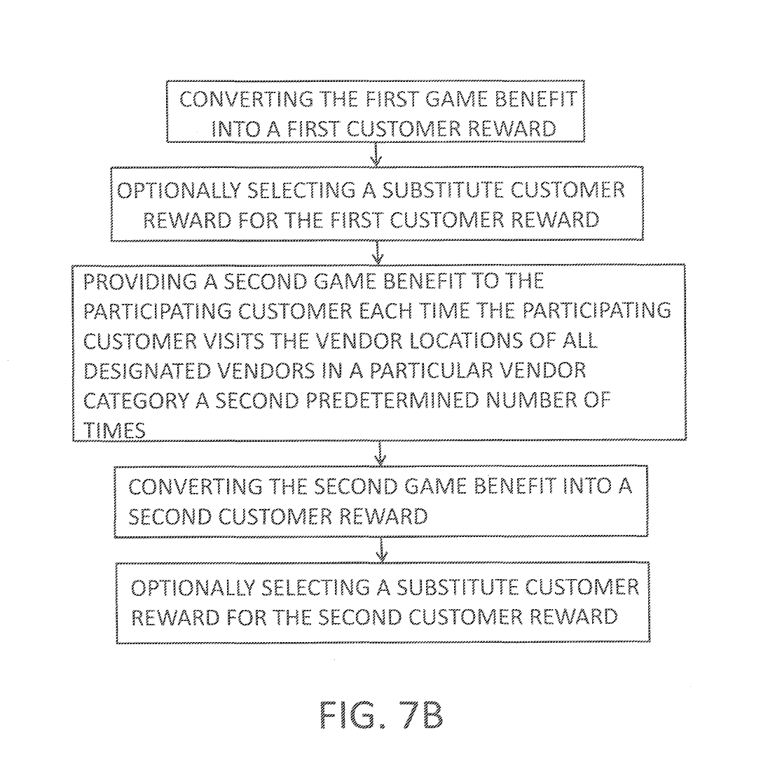

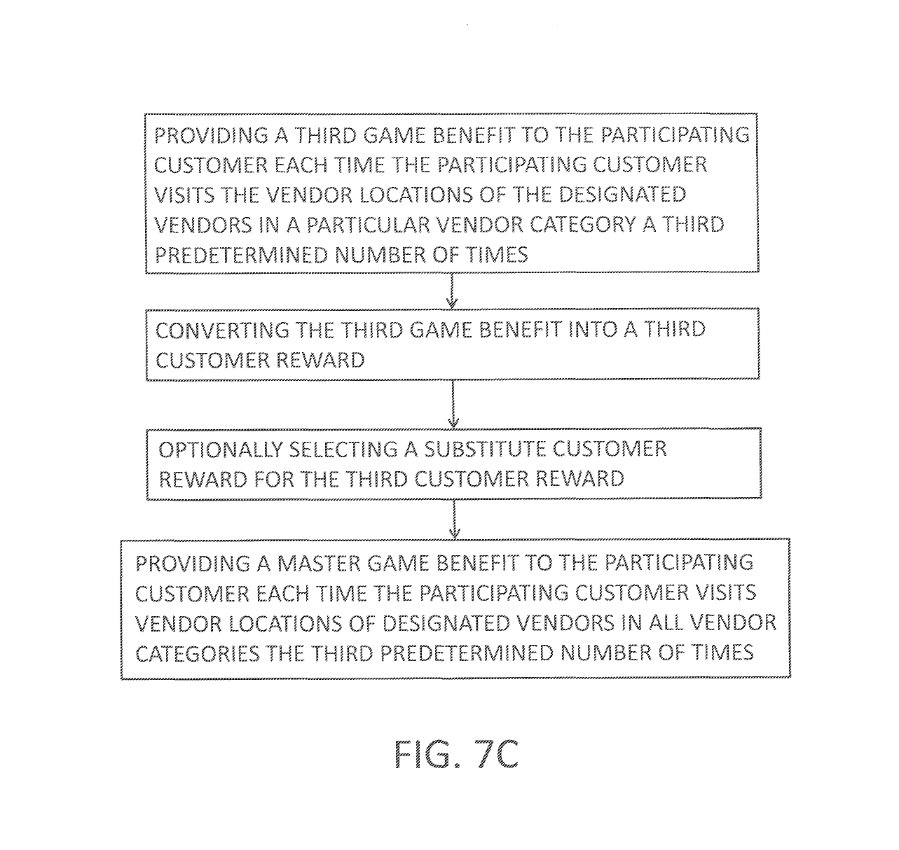

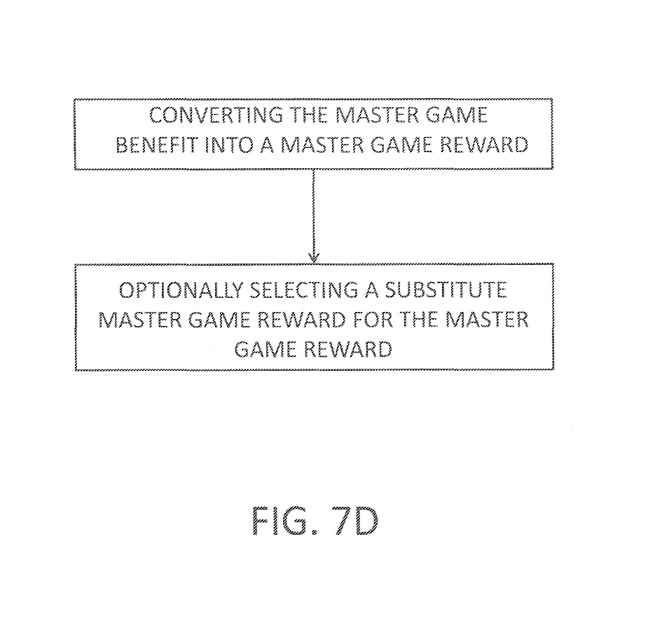

At any time a participating user may utilize his computing device(s) 16₁ . . . 16_{N} to communicate with the computing device 12 and thereby initiate, by the computing device, a marketing game to be played by the participating user. Alternatively, the marketing game may be initiated automatically on the participating user's computing device(s) 16₁ . . . 16_{N} by the computing device 12 after, for example, a check-in procedure has occurred and the computing device 12 has updated the game status of the user. FIGS. 7A-7D illustrate various representative aspects of this marketing game.

Those steps include identifying multiple vendor categories for the game. Substantially any categories may be utilized including, for example, national restaurant chains, local restaurants, national retailers and local retailers. Next the participant user uses his computing device(s) 16₁ . . . 16_{N} such as a smartphone or another computing device to communicate with the game system computing device 12 and designates, by the computing device 12, desired vendors to fill in the represented grid. The computing device 12 tracks, by communicating with the computing device(s) 16₁ . . . 16_{N} each time a participating user visits one of the participating vendor locations of vendors designated for a vendor category in the game and provides a first game benefit to the participating user each time the participating user visits the vendor locations of all the designated vendors in a particular vendor category a first predetermined number of times (for example, three times). The game method further includes converting by the computing device 12, the first game benefit into a first user reward. The game then includes an optional step allowing the participating user to select a substitute user reward for the first user reward should the user so desire. The game also provides, by the computing device 12, a second game benefit to the participating user each time the participating user visits the vendor locations of all designated vendors in a particular vendor category a second predetermined number of times (for example, six times). This is followed by the converting, by the computing device 12, of the second game benefit into a second user reward. Once again, the participating user then has the optional step of selecting a substitute user reward for the second user reward if the user so desires.

This is then followed by the step of providing a third game benefit to the participating user each time the participating user visits the vendor locations of the designated vendors in a particular vendor category a third predetermined number of times (for example, nine times). This is followed by the converting of the third game benefit into a third user reward. Once again the participant user is then provided with the optional step of selecting a substitute user reward for the third user reward.

Finally, the game method includes providing, by the computing device 12, a master game benefit to the participating user each time the participating user visits vendor locations of the designated vendors in all vendor categories for a predetermined number of times such as the third predetermined number of times previously mentioned. This is followed by the converting, by the computing device 12, of the master game benefit into a master game reward for the participant user. The participant user may then optionally select a substitute master game reward if desired.

Of course, alternative embodiments of the described marketing game are contemplated. The following example further illustrates and details an embodiment of the location based marketing game. As should be appreciated, however, this example is illustrative in nature and not limiting in scope.

### Example 1

### The Xooker Game

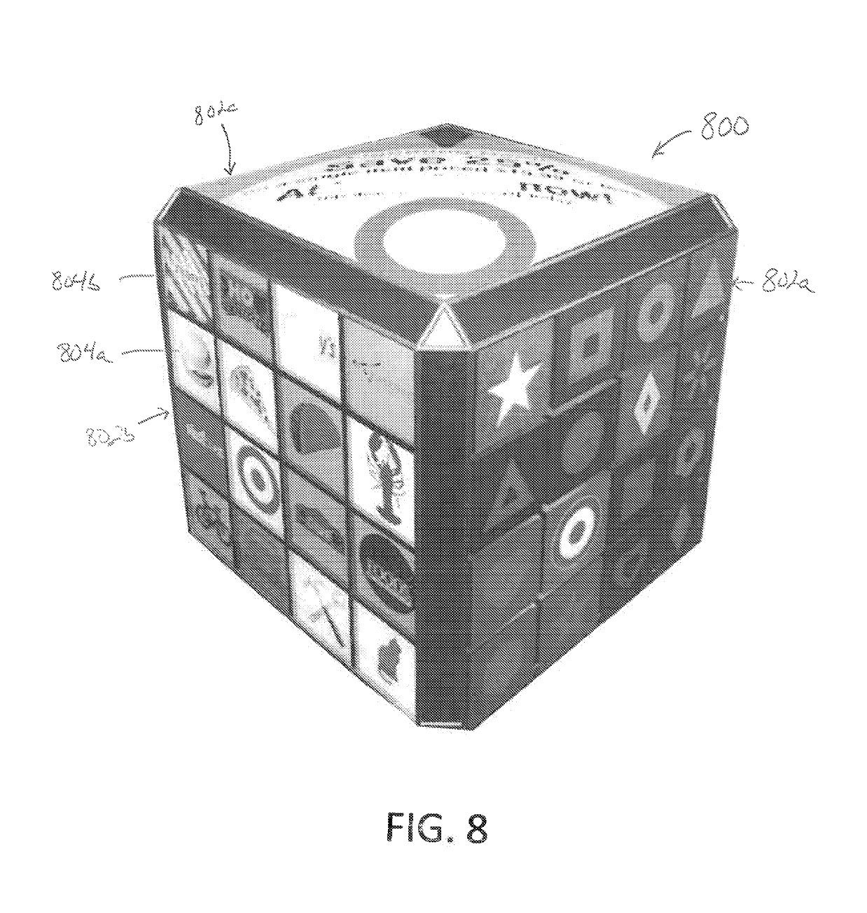

Xooker is an interactive game consumers play on their mobile phone to win prizes at their favorite restaurants and stores. To play, users download the Xooker application to one or more of their computing device(s) 16₁ . . . 16_{N} and register an account. The application is presented to the user as a user navigational interface presented on a computing device display screen as a three-dimensional FIG. 800 (see FIG. 8), which may be rotated in a variety of directions by a user to access different faces thereof. Such technology is known in the art. Rotation may be accomplished by a variety of means, such as clicking or dragging a side of the three dimensional user navigational interface with a mouse pointer to cause the interface to rotate in a desired direction, by touching or swiping the three dimensional user interface displayed on a display screen having touch-screen technology, etc. Such technology is also known in the art.

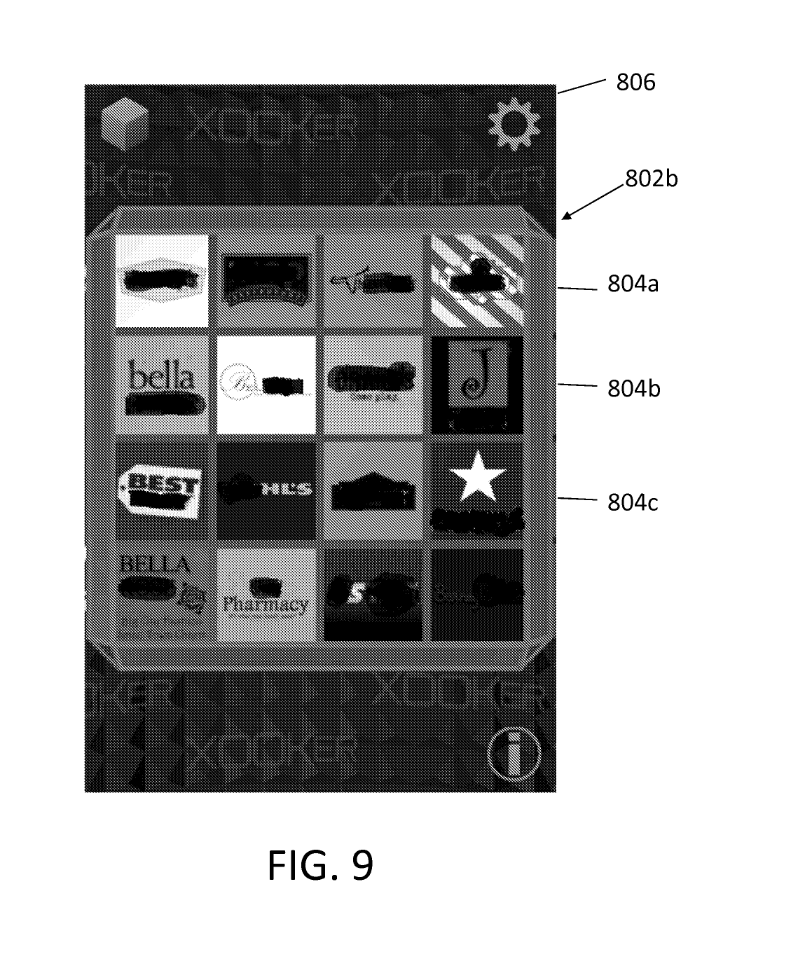

In the embodiments depicted herein, the three-dimensional user interface is displayed as a six-sided cube 800 (see FIG. 8). However, it will be appreciated that a variety of three-dimensional figures are suitable and contemplated for use herein, such as a triangle, a polyhedron, an octahedron, etc. The requirement is that the three-dimensional user navigational interface provides a plurality of faces 802a, 802b, 802c, . . . 802n, at least some of which display grids comprising multiple blocks 804a, 804b, . . . 804n which may be viewed by a user. By rotating the three-dimensional user navigational interface to the desired face, the user may access particular aspects of the disclosed marketing system. For example, in the embodiment depicted in FIG. 9, a user has accessed a particular face 802 b including blocks 804a, 804b, . . . 804n representing particular vendors of goods and services.

In an embodiment, the game consists of a three-dimensional user interface 800 defining a cube having six faces 802a . . . 802f each presenting a 4×4 grid of four rows of blocks 804a, 804b, . . . 804n. For the embodiment of FIG. 9, each row of face 802b may be based on the type of vendor, such as a national retailer, national restaurant, local retailer and local restaurant, although other arrangements and configurations are contemplated for inclusion of vendors. Each row contains four squares, each square representing a vendor such as a restaurant or retail store. For example, each square may display a particular type of vendor (restaurant, hardware store, bicycle shop, veterinarian, etc.) either by a generic display indicative of the vendor business type or by a display more specific of a particular vendor, such as by displaying a vendor's registered trademark. Typically, a user will select the particular favorite vendors, such as from a drop-down menu, to populate the rows of blocks 804a, 804b, . . . 804n (i.e., a “loyalty grid”). In this way, the user can select vendors that the user typically patronizes, and can accrue rewards for their continued patronage. A user may replace a particular vendor as desired, although one or more check-in events for the replaced vendor may be lost by such replacement. When a user checks in at a participating selected business they accrue a predetermined amount of reward points and the specific block 804a, 804b, . . . 804n pertaining to that vendor is highlighted if the vendor is one of the vendors selected by the user for their loyalty grid. At check-in, a confirmation screen may be automatically displayed or may be provided as a user-accessible option, confirming the user check-in and making available a screen showing the amount of reward points the user has accrued. When four blocks 804a, 804b, . . . 804n are highlighted (which can be vertically, horizontally, or diagonally), the user may then proceed to a reward selection step.

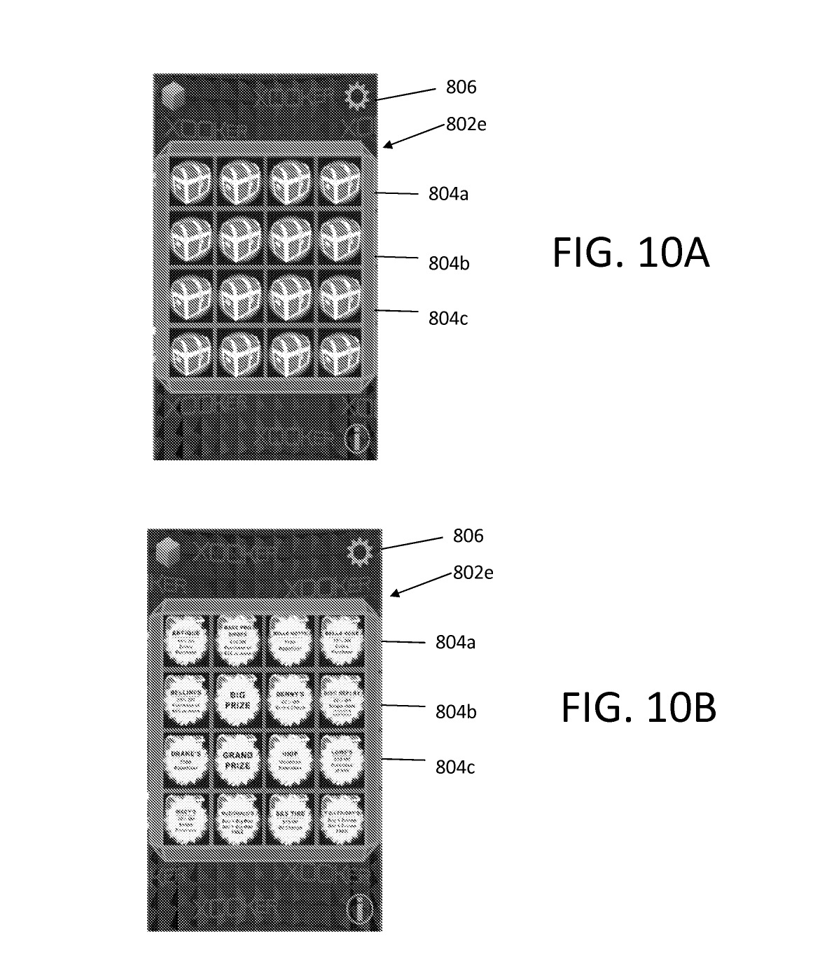

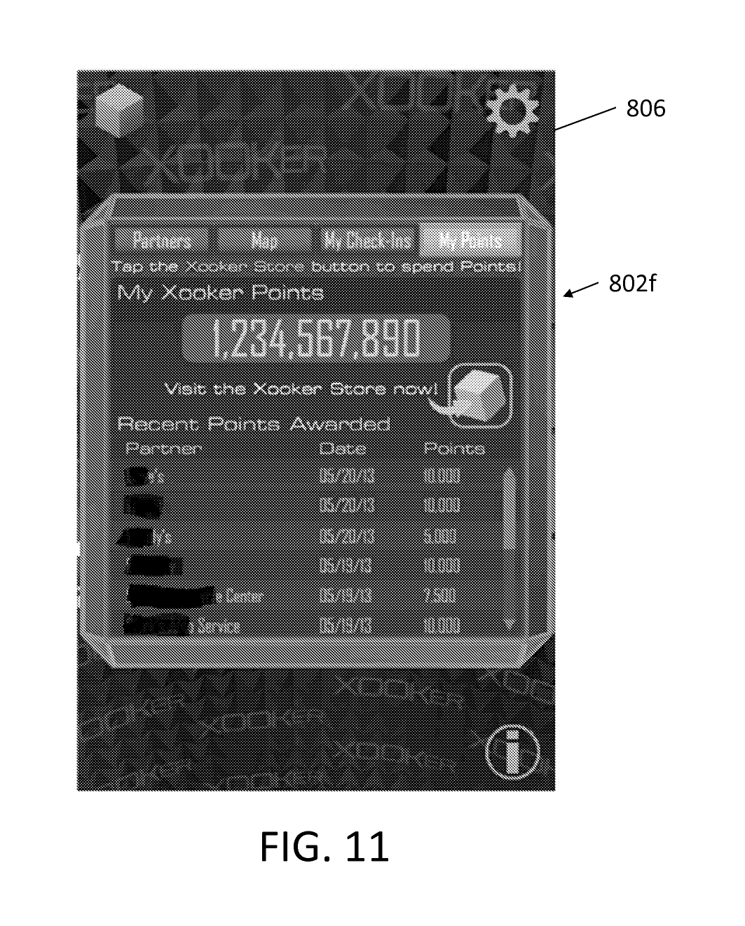

In an embodiment, after a user has been automatically checked in and confirms that sufficient blocks 804a, 804b, . . . 804n are highlighted to merit a reward, a prize grid may passively appear or may be actively accessed by the user (see FIGS. 10a and 10b) depicting, for example a grid of icons which reveal prizes to which the user is entitled based on the points accrued. Those prizes may be offered by vendors selected by the user for their loyalty grid, may be from other participating vendors, or both. In an embodiment, after the user has viewed available prizes, the icons may be scrambled and the user is prompted to select an icon. That icon reveals the prize the user has selected, which may be accepted by the user or traded for a different icon/prize.

In an alternative embodiment, a user is awarded a star (for example, a bronze, silver, or gold star, based on the number of times the user has checked in at that location). By accumulating enough stars, a user is awarded the key to a treasure chest containing a prize. The user advances through the game by visiting a location of each of the participating retailers. At the end of each level there is a grand prize. There are multiple levels. Xooker Points can also be earned through the game.

In an embodiment, each block 804a, 804b, . . . 804n may be configured as an icon which a user may select, such as by clicking with a mouse pointer or stylus, or by tapping the icon on a touchscreen display. In this embodiment, one or more of blocks 804a, 804b, . . . 804n may link to a display showing information provided by or on behalf of the vendor, such as the vendor's Web site, or at least a Web page displaying selected information about that vendor, or may cause a promotional video sponsored by the vendor to play within the selected face 802 of the three-dimensional user interface 100.

Although the game is primarily intended to be a mobile experience, the user can configure the game and view their game status through the website.

### Xooker Mobile Application

The Xooker mobile application is a key component in the Xooker game but provides other functionalities. Mobile users are offered the opportunity to play the above-described game by checking in while visiting participating businesses. In an embodiment, whenever the mobile application is open and active on the user's computing device, the disclosed system automatically performs the check-in procedure described above at predetermined time intervals to determine (and inform the user) whether the user is within a predetermined distance from a participating vendor. Alternatively, or as a supplement to, the automated check-in procedure, a user-initiated check-in may be implemented. The geo-location component described above is used to identify the user's location and automatically updates their status within the above-described Xooker game. Users can also view the Xooker “Deal of the Day” offered by the business, or buy the Xooker “Prepaid Deal” for that business. The mobile application also has the ability to search for deals offered by all participating businesses by category and/or location, and gives the user the ability to view and maintain his/her account status. A user may also review their check-in history, points accrual, etc., such as by clicking or tapping an appropriate icon associated with their “loyalty grid” display to display one or more drop-down menus displaying that information. That information is then displayed on the selected face of the three-dimensional user navigational interface (see FIG. 11).

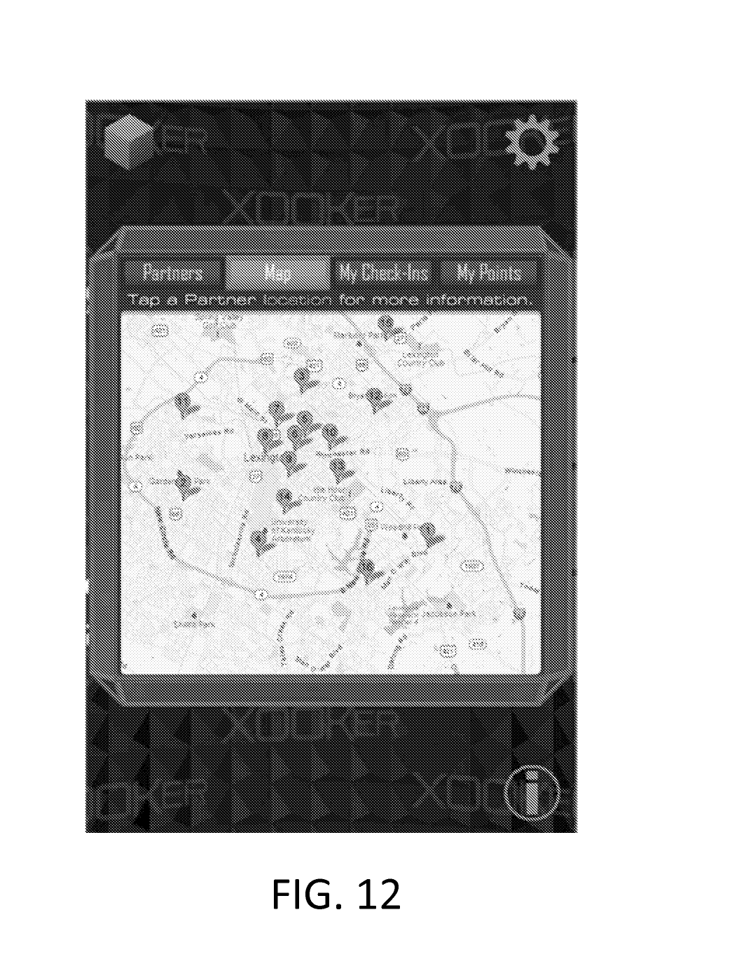

As described above, a map function may be associated with the three-dimensional user navigational interface 800. A user may access the map function by clicking or tapping an appropriate icon 806 associated with their “loyalty grid” display (see FIG. 9) to display one or more tabs and/or drop-down menus, and selecting the map function from the appropriate drop-down menu. That information is then displayed on the selected face of the three-dimensional user navigational interface (see FIG. 12). As discussed above, the map function may display all participating vendors within a predetermined distance radius from the user's determined location, for example within two miles. Of course, the user may set that predetermined distance radius as desired. In an alternative embodiment, the map function may automatically be pushed to the user's computing device(s) 16₁ . . . 16_{N} whenever a check-in procedure is initiated and, for example, a determination is made that the user is not within the predetermined distance from a participating vendor.

The Xooker mobile application can be synchronized with a user's social media applications, such as user TWITTER and FACEBOOK accounts. Xooker users have the option to use their social media accounts to register, check-in with, and can optionally, automatically tweet or update their status on their social media pages every time they check-in at a participating business.

Xooker Deals

The disclosed system includes a capability to push featured vendor deals and promotions to users via their computing device(s) 16₁ . . . 16_{N} and the Xooker website, allowing them to find participating retailers and restaurants that are close to their present location and to confirm user check-in, points accrued, and static vendor advertisements appropriate to the user. The automated check-in procedure also automatically updates the user's status on the game described above. Users can also sign-up for the Xooker Newsletter, which delivers email deals and up-to-date news on what's happening with Xooker in their desired area and categories of interest.

In embodiments, different types of deals may be offered to users, such as for example predetermined discounts for goods or services, offers of free goods or services, and the like. For example, the Xooker Prepaid Deal may be a minimum of 50% off the standard price of the item being promoted. Consumers will be able to select prepaid offers from specific categories and receive them via the mobile app or email. The Xooker Daily Deals may offer “Free Daily Deals” to consumers. Businesses may post daily deals that consumers will not have to pre-purchase. Offers will be valid for a limited time and can be posted and managed directly by the vendor or business. Consumers can access these offers through the Xooker website or Xooker mobile app. Consumers who request offers by category will receive them only in the areas of interest they pre-selected. One daily deal in each category will be sent to the consumer each day, with the other deals being accessed through the website or via the mobile app. Consumers will be able to select which type of offers they are shown when they search for deals using the Xooker app on their mobile phone. Consumers will be able to search for businesses and offers within a specific geographical area (city, zip code or within a 2 mile radius of their location).

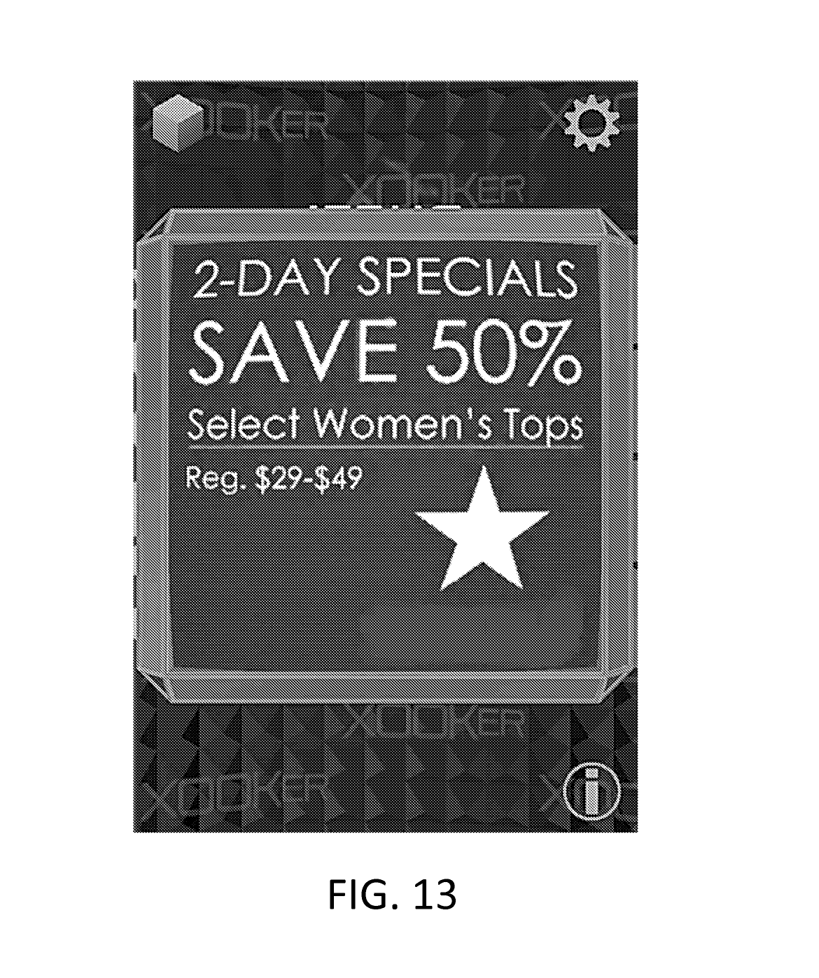

In other embodiments, a particular face 802n of three dimensional user interface 800 (see FIG. 8) may be reserved for a vendor offer that is replaced on a rotating basis (a “Featured Deal”), such as daily or weekly. On user access of that face 802n, the vendor offer is presented to the user. See FIG. 13. The vendor offer may be a particular discount as described above, may be a free offer to encourage a user to visit the vendor, may be a listing or drop down menu of all available offers for a particular day or week, etc. A list of vendor offers already selected or purchased by the user may be stored in memory and viewed by the user via an appropriate tab or drop-down menu.

Another face of the 802n of three dimensional user interface 800 may be reserved for display of the above-described vendor grid as part of the described marketing game. Still another face 802n may be reserved for display of the above-described rewards grid. Yet another face 802n may be reserved for display of a Settings feature, wherein a user may make changes to the configuration of the various faces 802n and to the information displayed thereon according to user preference.

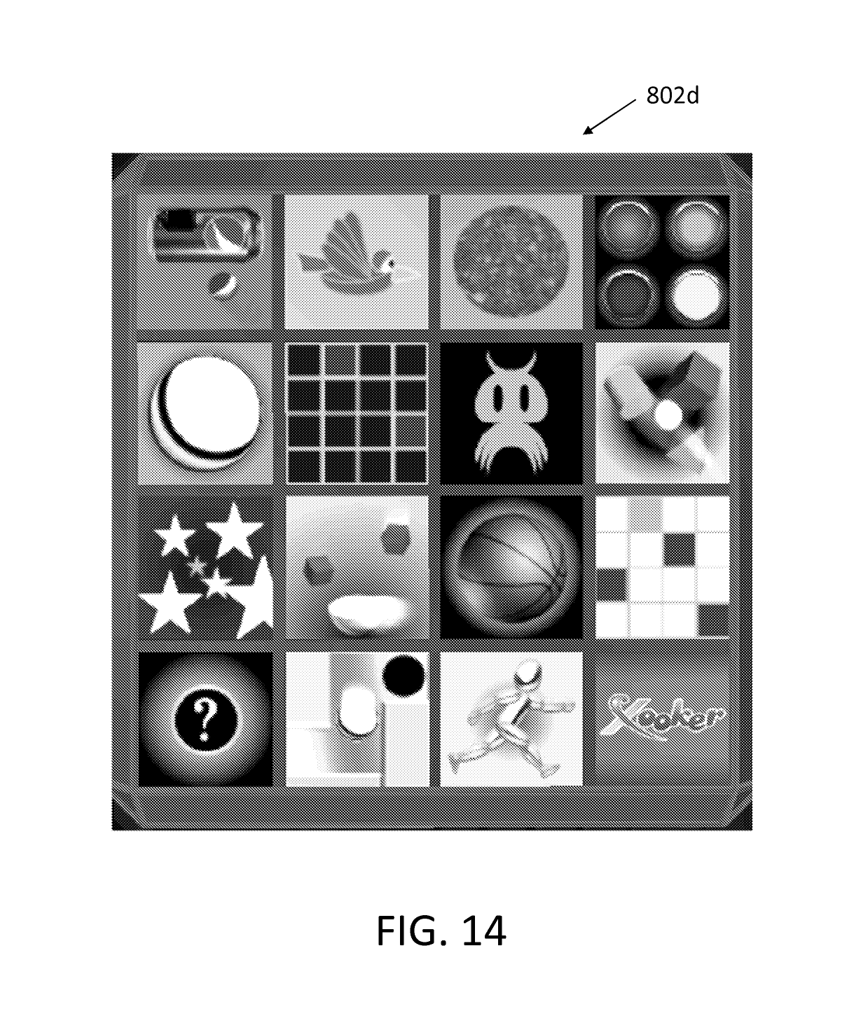

Another face 802n of the three dimensional user interface 800 may be reserved for a game grid (see FIG. 14), wherein various proprietary or third-party games (distinct from the marketing game described above) may be included in the application for access and play by the user. Much like the description above of the vendor “loyalty grid,” the blocks of the “game grid” face may be pre-populated with various default games, or may be populated with games selected by the user from the Settings face, which may be accessed for play by clicking or tapping on the block associated with the desired game.

Xooker Checkin'

Every time the user visits a participating business, the Xooker Checkin' portion of the mobile application automatically checks the user in and updates their game status. It may then optionally send a push notification and/or play a short promotional video provided by the vendor or business they are currently visiting. Then, the user will be shown any alerts triggered by their latest check-in, and information about the special deals offered by the business.

Xooker Checkin' also allows a participating business to award special promotions for initial check-ins or for a particular number of check-ins (i.e. every 5^{th}, 10^{th} or 15^{th} check-in, etc.).

Still more, the automated check-in procedure described above provides vendors with an opportunity to utilize user visitation metrics in substantially real-time to determine whether a particular user is a regular visitor to the vendor or has not visited the vendor in some time, and to provide incentives via a face 802 of the three-dimensional user interface 800 for the user to resume patronage of the vendor's business. As part of the above-described process, user visits to a vendor are logged and maintained as a database such as at computing device 12. When a user visits a vendor, the automated check-in procedure described above is performed. If it is determined that a user has not visited the vendor in some time, vendor advertising, offers such as discounts, or other incentives may be pushed to the user's computing device(s) 16₁ . . . 16_{N} to incentivize the user to return to the vendor more often. This can be accomplished by reviewing the user visit database, and if a user has not visited a vendor in a predetermined period of time or has not visited the vendor a predetermined number of times over a predetermined time period (a threshold number of visits), initiating the described providing of incentives.

Similarly, the automated check-in procedure described above provides vendors with an opportunity to stimulate “walk-in” user traffic. For example, a user may be within a predetermined distance, but not actually within the establishment, of a vendor. By being within that predetermined distance, the automated check-in procedure may be initiated, and as part of that process an automatic contact from that vendor is initiated with the user via a face 802 of the three-dimensional user interface 800. For example, a simple message may be displayed (potentially as part of the map functionality described above) informing the user that “you are within X distance of Vendor Y.” Alternatively, a specific vendor offer may be pushed to the user's computing device(s) 16₁ . . . 16_{N} to incentivize the user to enter the nearby vendor's establishment, such as one or more offers of discounts on purchases, free goods or services, etc.

Xooker Mobile Rewards

Xooker Mobile Rewards is a loyalty program for retail and restaurant clients. Restaurants & retailers can designate the value of the reward points or dollars that consumers can earn with the items or dollar amounts purchased. Xooker points are awarded based on the total amount spent at the business' locations or on specific items purchased. Xooker will track the loyalty rewards to verify the amount spent at the restaurant/retail location. The point of sale terminals will print a bar code at the bottom of each receipt that will contain the amount of the ticket and the date and time of the visit. Additionally what was ordered/purchased will be contained in the bar code. Xooker mobile loyalty reward points for retail and restaurant clients can be used in conjunction with current rewards programs. Consumers will be able to track their loyalty rewards for each business either online at Xooker.com or via their mobile phone 16₁, 16_{N}.

Xooker Points

Consumers can earn Xooker points when they purchase pre-paid Xooker Deals or gift cards. Points will also be earned when existing members invite friends to join Xooker. Other methods of earning points will be through the Xooker loyalty reward game, as well as mobile entertainment games that will be hosted on Xooker. Points can be used by consumers to receive additional discounts when purchasing Xooker pre-paid deals and gift cards.

Additional Details of the Xooker Game and Xooker Checkin'

Game Logic

To play, users download the Xooker application to their mobile device 16₁, 16_{N} and register their account. They may then be prompted to invite friends from their contact list as well as their social media sites, which will earn them Xooker points.

In an embodiment, the game board has 4 sections (rows) each with 4 columns:

1) National Restaurants

2) Local Restaurants

3) National Retailers

4) Local Retailers

Once a user creates an account, he or she browses a list of national and local restaurants as well as national and local retailers they would like to place on their game board. They select 4 businesses/locations from each section. For example, in Section 1 for National Restaurants, they could choose from a list of national restaurant chains having locations in the users geographical area. Then, when the user visits one of the restaurants or retailers they have listed on their game board, they are automatically checked in using the Checkin' function on the Xooker mobile application. The application uses geolocation to verify that the user is in fact at a participating business. Each of their Checkin's earns the user a predetermined amount of Xooker points and advances them towards earning prizes as described above.

For the following example we will use the National Retailers section. The user will select 4 national retailers from the list of participating businesses. These national retailers have locations in the geographical area where the user is shopping, and as explained above the user has prepopulated this face of the three-dimensional user navigation interface by selecting from a list of vendors. When the user visits one the participating vendors, for example a retail store or restaurant, they are automatically checked in by the Xooker application loaded on their smartphone. Using geolocation, the Xooker system confirms the participating vendor location at which the user is located. An optional short 15 to 30 second promotional video (selected and pre-loaded into the system by the vendor) plays on the users' smartphone. In one embodiment, for the user to receive Xooker points for this check in, the video must be viewed in its entirety. After the video completes, the mobile application displays any games alerts that may have been triggered by the user's latest check-in. For example, if the user has visited three out of the four businesses they selected in any row (vertical, horizontal, or diagonal), the system could pop up an alert saying they only need to visit one more vendor to earn their next reward. The application would also update the user's social media sites as described above, if the user had selected those functions when installing and configuring their game.

After the user has accrued sufficient points, as described above they will be entitled to select a prize. The user can click on the icon and play the game instantly on their mobile phone or choose to play it later on their PC, laptop or other computing device. The prizes awarded will be from one of the four vendors in that section. The user will continue to upper level rounds after each round of visit, for example once the user has visited each business in each section at least 3 times. The users will receive Xooker points for each additional visit to their selected businesses after the 3^{rd} check-in for each level. As additional check-ins or rounds of check-ins (for example, a predetermined number of visits of each vendor in the “loyalty grid” face of the three-dimensional user navigational interface as described above), the user may be entitled to receive prizes of increasing value.

The Xooker game encompasses multiple levels that the user can achieve. At each new level the user will have the option to choose new restaurants and retailers for their game board. The value of each available prize will be greater than the prior level. This too will give incentive to the users to continue to play Xooker and receive valuable prizes such as gift cards and trips. Higher levels will have 1 to 2 pre-selected businesses in each category which businesses will pay a premium to insure increased user traffic. Users will be willing to try new locations because of the opportunity to win more valuable prizes.

Xooker Checkin'

A component of the system may be maintained separate from the above-described game, where users earn points simply for checking with a participating vendor. In other words, the vendor may offer rewards to the user for simply achieving certain number of check-in procedures.

Checkin' rewards can be tallied one of two ways. First, a reward can be earned for every 10 (or whatever number the vendor chooses) Checkin's. The vendor also chooses the reward earned.

The second method is by total number of Checkin's. The vendor has the option to set up to five levels of rewards, the number of total Checkin's required to earn the reward at each level, and the reward earned. After the user earns the highest reward, the system resets and they start over.

Each type of promotion can be programmed to start and end on pre-defined dates. A maximum of one Checkin' per location per day may be implemented.

Xooker Loyalty Rewards

Loyalty Rewards are based on number of dollars spent. The participating vendor or business is able to set the dollar amounts necessary to earn each reward and what the reward is.

The Xooker Mobile Application

The Xooker Mobile Application is the primary method for user interaction with the Xooker system. Through this app, users receive deal alerts, view and purchase Deals, check-in when visiting a participating location, view their Xooker game status, refer friends and manage their Xooker accounts.

The operation of the mobile application is as automatic as possible, and takes advantage of geolocation to the greatest practical extent. Based on the user's location, the mobile app automatically selects one of two modes. If the user is at a participating vendor location, the app automatically enters check-in mode (see FIG. 5B). If the user is not at a participating location, the application may display a map of the user's current location (See FIG. 6B). This feature may be a passive feature, i.e. occurs automatically on determination that the user is not at a participating vendor location, or may be active, requiring the user to select the map functionality to find participating vendor locations near the user's current location. This map in an embodiment displays pushpins indicating participating businesses within a predetermined distance radius which may be a default value or may be set by the user. There is also a Search Deals function, a Xooker Game function and a My Account function which are not based on geolocation. These modes and functions are described in more detail below.

The following features represent the minimum functionality necessary to achieve full system functionality.

Download Mobile Application

The application may be made available for download via a number of commercial sites that are easily accessible from the user's computing device(s) 16₁ . . . 16_{N}.

Install the Application

The application has a simple, intuitive installer which guides the user through installation and configuration.

Configure the Application

The following options are configured in order for the application to be usable with the Xooker system:

Enter, or otherwise determine, the User's electronic contact address.

An email, text, instant messaging, or other contact functionality is used in order to send the user alerts and vendor offer information. In one possible embodiment, the application configuration utility automatically pulls the user's email address from information stored in the user's mobile device and pre-populates the email address field, giving the user the opportunity to edit the information.

Enter the user's home city, state, zip code and preferred categories.

This information is provided to select and display Xooker deals on the website that are based on the user's home location, and if geolocation data is not available, on the user's computing device(s) 16₁ . . . 16_{N}. In one possible embodiment, this information is pulled automatically from the user's computing device(s) 16₁ . . . 16_{N} and the fields are pre-populated, giving the user the opportunity to update them.

Choose Alert Categories

Deals (vendor offers) may be separated into Categories, which are then used to ensure the users only get updates on products and promotions that are of interest to them. Alerts are sent to the user on a regular basis either through email or directly to the user's mobile device via the Xooker app.

Choose Alert Preferences
Opt in to the email alerts sent daily to the user's email address
Opt in to the mobile alerts sent daily to the user's cell phone
Opt in to messages sent via the mobile app which alert the user of what they have to do to achieve the next reward. For example, “Visit any Vendor X location to earn a key to the Treasure Chest.”

There will be an “Advanced” feature where users can select individual business locations whose alerts will always be sent.

Option to Automatically Update the User's Social Media Presence, Saying that they'Re Visiting the Participating Xooker Business.

If the user selects either or both of these options, the mobile app automatically updates the user's Facebook status and/or Twitter feed with a message about the business the user is visiting.

Option to Send Invitations to the User's Contacts and/or Social Media Followers.

The user has the option to send an invitation to the contacts in the user's mobile device, or to their social media followers and earn points for each accepted/registered invitation. The system tracks all invitations through the registration process and provides a report (available via the superuser port 62) showing how many invitations were sent out and how many resulted in new user registrations.

Setup the Game Board and Choose Vendors

This step can be made mandatory in order to play the Xooker game. It is accessed during installation and each time a user completes a level of the game by visiting all 16 locations (three times each) on the game board. At that point in the game the user is able to choose new retailers and locations for the next level.

Configuration Data is Transmitted Securely to the Xooker Servers

User information entered into one or more of the computing device(s) 16₁ . . . 16_{N} is transmitted to the Xooker computing devices or servers 12 via a secure connection. Any number of suitable secure communications protocols and encryption protocols are contemplated for use herein, including future developed communications protocols/encryption protocols.

Search for a Vendor

The user can type keywords into the Search Box and the system will return matching vendors within the user's current metropolitan area. The search routine will search: Keywords, Vendor's Name, Street Address and Categories.

Advanced Browse/Search

The user can browse or search for participating businesses outside of the current geographical area by any combination of Keywords, Category selection or Geographical location by City and State or Zip Code.

View Game Board and Game Status

This function displays the Game Board, showing all of the locations the user had visited and which round the user is playing for that location. It also displays Xooker point totals and any alerts telling the user when they're close to achieving the next prize.

View Xooker “Free Deal of the Day”

The “Free Deal of the Day” is displayed according to the following priority. If the current location has a vendor deal loaded into the system, it is displayed. If there is no Free Deal for the current location and the vendor is part of a national chain, the system searches for a Free Deal entered by the national retailer or restaurant. If no deal is found, the system displays the Xooker Sponsored Deal for the day.

View and Purchase Xooker “Prepaid Deal of the Day”

The “Prepaid Deal” is displayed according to the following priority. If the current location has a deal loaded into the system, it is displayed. If there is no Prepaid Deal for the current location and the location is part of a national chain, the system searches for a Prepaid Deal entered by the national retailer or restaurant. If there is no deal for the retailer or restaurant the prepaid deal for the zip code is displayed. If there is no such deal, the deal for the city is displayed. If nothing comes up the application displays an alert, for example “No participating businesses in your area”, with options to view all deals in the user's area or all deals.

Search for and Purchase Free, Prepaid and Sponsored Deals by Category and/or Location

The user has the option to view (and purchase, if applicable) all deals in the system by category and/or location, not just those displayed on the mobile map showing the user's present location. The user has the ability to change the zoom level.

Buy a Xooker Gift Card

Users are able to purchase Gift Cards of various types from their computing device(s) 16₁ . . . 16_{N}.

Send to a Friend

The user has the option to send any deal viewed by the user to a friend. The system tracks and logs each time a deal is sent to a friend, and the user may accrue points for providing such contacts.

Edit Account Info and Preferences

This feature gives the user the ability to edit their information and preferences. This is separate from the game configuration.

View Banner Ads

One or more faces 802 of the three-dimensional navigational interface 800 may display banner advertisements from the Xooker inventory.

Website Component

The Xooker website will allow users to view, search for and purchase Xooker deals. Users can also sign up to participate in Xooker promotions, set up their Xooker Game Board, view their game status, leave comments, refer friends and manage their Xooker accounts and purchase gift cards.

It will be appreciated that all of the above functionalities and options are automatically made available to the user's computing device(s) 16₁ . . . 16_{N} upon installing the above described application. Thus, for example, the user does not need to close a particular game block or a particular vendor grid, access the program for a next game or vendor, and download and open that next game or vendor. Instead, the user simply minimizes the existing open game or vendor, clicks or taps on the block corresponding to the next desired game or vendor, and opens that next game or vendor. All of the information relating to each game, vendor, reward, etc. is made available to the users computing device 16₁ . . . 16_{N} upon installing the application, and so the user does not need to access third-party sites to retrieve additional information. From the vendor perspective, because of the automated check-in procedure and other features described above, the vendor is able to target its marketing and promote user loyalty without needing to maintain large databases of user information or directly target users, such as by mass e-mails. Instead, the exchange of information between the user and vendor is substantially automated by the methods and systems described above. Likewise, other functionalities of the application as described above are automatically made available to the user simply by installing the application on one or more of the users computing device(s) 16₁ . . . 16_{N}.

The various embodiments set forth herein are described in terms of exemplary block diagrams, flow charts and other illustrations. As will become apparent to those skilled in the art, the illustrated embodiments and their various alternatives can be implemented without confinement to the illustrated examples. Thus, the block diagrams, flow charts, all drawing figures and their accompanying description should not be construed as mandating a particular architecture or configuration.

One of ordinary skill in the art will recognize that additional embodiments of the invention are also possible without departing from the teachings herein. Thus, the foregoing description is presented for purposes of illustration and description of the various aspects of the invention, and one of ordinary skill in the art will recognize that additional embodiments of the invention are possible without departing from the teachings herein. This detailed description, and particularly the specific details of the exemplary embodiments, is given primarily for clarity of understanding, and no unnecessary limitations are to be imported, for modifications will become obvious to those skilled in the art upon reading this disclosure and may be made without departing from the spirit or scope of the invention. Relatively apparent modifications, of course, include combining the various features of one or more figures with the features of one or more of other figures. All such modifications and variations are within the scope of the invention as determined by the appended claims when interpreted in accordance with the breadth to which they are fairly, legally and equitably entitled.

What is claimed:

1. In a computing system environment, a location-based marketing method for marketing vendor products and services, comprising:
providing at least one first computing device including at least one memory operatively coupled to at least one processor, the at least one memory storing at least a listing of participating vendor geographical locations;
providing at least one second computing device in computing communication with the at least one first computing device;
displaying to a second computing device user on a display screen of the second computing device a rotatable three-dimensional navigational interface including a plurality of faces;
by a geolocator module of the second computing device, providing to the at least one first computing device a geographical location of the user;
comparing said provided geographical location of the user to the stored listing of participating vendor geographical locations; and
on determining a match of said user geographical location and one of said participating vendor geographical locations, initiating by said first computing device a user check-in procedure displayable on said rotatable three-dimensional navigational interface, said check-in procedure being specific to the determined matching participating vendor.

2. The method of claim 1, further including displaying to the user within a face of the three-dimensional navigational interface a check-in confirmation screen for confirming said check-in procedure with said matching participating vendor.

3. The method of claim 1, further including, if the user location does not match one or more of the participating vendor locations, displaying to the user within a face of the three-dimensional navigational interface a mapping functionality to determine whether said user location is within a predetermined distance of said one or more participating vendor locations.

4. The method of claim 3, wherein said mapping functionality is actuated by the user via a tab and/or a drop-down menu functionality associated with the face of the three-dimensional navigational interface.

5. The method of claim 1, further including initiating, by said first computing device, a marketing game which may be played by said participating user within at least one face of the three-dimensional navigational interface.

6. The method of claim 1, wherein said check-in procedure optionally includes displaying to the user on a face of the three-dimensional navigational interface one or more of a check-in confirmation screen, a participating vendor promotional video, a page of information about the participating vendor, and a vendor advertisement, and an unsolicited vendor offer of goods and/or services.

7. The method of claim 1, wherein the three-dimensional navigational interface includes at least one face displaying a grid of user-selected participating vendors, at least one face displaying a grid of user-playable games, and at least one face displaying one or more selected vendor offers of goods and/or services.

8. The method of claim 1, wherein said check-in procedure includes storing on a memory of said first computing device at least a number of times the user has visited one or more of said participating vendor geographical locations.

9. The method of claim 8, wherein said check-in procedure further includes initiating, by said first computing device, displaying to the user on a face of the three-dimensional navigational interface a user reward status including any currently earned user reward and/or remaining requirement to earn a next user reward.

10. The method of claim 9, further including determining from said number of times a user has visited one or more of said selected vendor locations a game benefit from which the user may realize a user reward from at least one of the participating vendors.

11. A networked computing system for location-based marketing, comprising:
at least one first computing device including at least one memory operatively coupled to at least one processor, the at least one memory storing at least a listing of participating vendor geographical locations;
at least one second computing device including at least a display screen, a geolocator module, and a computing communication module for providing to the at least one first computing device a geographical location of a user of the at least one second computing device;
at least one first computer program product embodied in a non-transitory computer readable medium which, when loaded on the first computing device, matches the geographical location of the user to the geographical location of a participating vendor, the at least one first computer program product having computer executable instructions for comparing said provided geographical location of the user to the stored listing of participating vendor geographical locations, and for initiating by said first computing device a user check-in procedure on said second computing device on determining a match of said user geographical location and one of said participating vendor geographical locations, said check-in procedure being specific to the determined matching participating vendor; and
at least one second computer program product embodied in a non-transitory computer readable medium and comprising computer-executable instructions which, when loaded on the second computing device, displays a navigational interface to the user, the at least one second computer program product having computer executable instructions for displaying to the user a rotatable three-dimensional navigational interface including a plurality of faces, said user check-in procedure being displayable on at least one of said faces.

12. The method of claim 11, wherein one of the plurality of faces displays to the user a check-in confirmation screen whereby the user may confirm said check-in procedure with said matching participating vendor.

13. The method of claim 11, wherein the at least one second computer program product includes computer executable instructions for, if the user location is determined to not match one or more of the participating vendor locations, displaying to the user within a face of the three-dimensional navigational interface a mapping functionality to determine whether said user location is within a predetermined distance of said one or more participating vendor locations.

14. The method of claim 13, wherein said mapping functionality is automatically displayed within a face of the three-dimensional navigational interface or is actuated by the user via a menu functionality associated with the face of the three-dimensional navigational interface.

15. The method of claim 11, wherein said at least one second computer program product includes computer executable instructions for displaying to the user on a face of the three-dimensional navigational interface a vendor reward status including any currently earned user reward and/or remaining requirement to earn a next user reward.

16. The method of claim 11, wherein said at least one second computer program product includes computer executable instructions for displaying to the user on a face of the three-dimensional navigational interface one or more of a participating vendor promotional video, a page of information about the participating vendor, and a vendor advertisement.

17. The method of claim 11, wherein said at least one second computer program product includes computer executable instructions for displaying a grid of user-selected participating vendors and one or more selected vendor offers of goods and/or services on predetermined faces of the three-dimensional navigational interface.

18. The method of claim 11, wherein said at least one first computer program product includes computer executable instructions for logging at least a number of times the user has visited one or more of said vendor locations stored in memory of said computing device.

19. The method of claim 18, wherein said at least one second computer program product includes computer executable instructions for initiating a marketing game which may be played by the user.

20. The method of claim 19, wherein said at least one second computer program product includes computer executable instructions for designating at least one vendor for inclusion in said game.

21. The method of claim 20, wherein said at least one second computer program product includes computer executable instructions for determining, from said logged number of times a user has visited one or more of said selected vendor locations, a game benefit from which the user may realize a user reward from at least one of the participating vendors.
